(19) United States
(12) Patent Application Publication
(10) Pub. No.: US 2001/0038185 A1
(43) Pub. Date: Nov. 8, 2001

(54) Wheeled system for transport of heavy loads

(76) Inventors: Gregory DeNoble, Boring, OR (US); James G. Pedersen, Tigard, OR (US); Ronald D. Olfert, Milwaukie, OR (US)

Correspondence Address: Ronald D. Olfert, 11414 SE 30th, Milwaukie, OR, 97222, US

(21) Appl. No.: 09/782,457

(22) Filed: Feb. 13, 2001

Related U.S. Application Data
(60) Provisional application No. 60/193,841, filed on Mar. 31, 2000.

(51) Int. Cl. B62D 21/00; B60P 3/40

(52) U.S. Cl. 280/79.11; 280/80.1

(57) ABSTRACT

A wheeled platform system for moving heavy or bulky loads wherein the system includes a plurality of wheeled platforms, each having a spacing element of thickness determined by the application placed upon said platform, a side wall integrated with the horizontal portion along the platform=s long edge, and multiple wheels at each end of each of two axles. The platform extends beyond the line of intersection of the axles with the platform to form a means by which when the load is tilted towards one end of the assembly the other end will be lifted off the floor. The wheels consist of commercially available ball or roller bearings of the appropriate size and strength characteristics to support the load range desired.

### CROSS-REFERENCE

Provisional Patent Application No. 60/193,841 Filed Mar. 31, 2000.

### BACKGROUND

1. Field

The field of the art contemplated herein includes devices which aid in the process of moving heavy loads from one place to another, more specifically, the field of wheeled land vehicles with means for supporting a heavy load in position on the vehicle while in motion and having an attached bolster plus an optional removable bolster and in which the axles are attached directly to a platform, and which uses multiple wheels at each end of each axle and in which each wheel is a ball or roller bearing and which uses a wear-preventing means between dual wheels.

There are available various conventional transporting devices which do not provide the novel improvements of the invention herein disclosed.

Search Classes 280/29,80.1,107,143,148,79.11; 301/36.1,36.2,36.3,5.1,5.3,5.7 of the US Patent and Trademark Office Classification System.

2. Description of the Background

In the past, in order to move a heavy object across a floor or in or out of a building, or into or out of a transport vehicle, various means have been used to support the load and reduce the friction so that the load can be moved easily by one or more workers or with a forklift.

All of the methods employed prior to this invention have characteristics which limit their usefulness and desirability in certain circumstances. For example, when moving a heavy piece of machinery, weighing up to 10,000 pounds, typically the heavy equipment mover will use multiple tracked devices, air bags, or multiple rollers under the load. All of these methods lack in maneuverability, that is, they permit easy movement in only a straight line, requiring re-positioning of the load and support system devices in order to change direction. This invention addresses this maneuverability issue by enabling easy pivoting of the load and thereby change of direction, without re-positioning the wheeled platforms while at the same time maintaining stability and support of the load.

The employment of this invention reduces the time and personnel needed to set up and complete a moving job within the range of load sizes and weights for which the invention is designed.

This invention reduces potential damage to the load as a result of slippage or breakage of any portion of the support system, as compared with prior dolly systems using wheels or tracks, by reducing the distance the load is raised from the surface In addition, the lower center of gravity of this invention as compared to other wheeled or tracked methods reduces the probability that the device will slip out from under the load or tip over.

The preferred embodiment of this invention is relatively small and light compared to other alternatives for moving heavy objects, thereby making it easier for the professional mover to stow and carry the devices.

This invention can be used in numerous configurations and can be set up to move a wide variety of shapes and styles of objects, to a greater degree than prior methods.

3. References

U.S. Pat. No. 4,066,272

U.S. Pat. No. 5,052,703

Catalogue: Global Industrial Equipment 1070 Northbrook Pkwy, Dept. L, Suwanee, Ga. 30174. Phone 770-995-0007.

### SUMMARY

The system of the present invention consists of a plurality of assemblies each comprising an elongated platform rigidly attached to and on top of two axles, each axle holding a plurality of wheels, preferably two, at each end. Each axle has a first diameter in the center portion selected with the objective of minimizing the distance between the bottom of the axle and the ground but still providing sufficient clearance so that the axle will not hit the ground while in use. A portion at the end of the axle is reduced sufficiently to securely hold the wheels attached thereon. The reduced portion of the axle extends outwardly past and perpendicular to the long side of the platform. The center portion of the axle is securely and permanently attached to the bottom of the platform, at a distance inwardly from the end of the platform such that the portion of the platform extending outwardly from the line of intersection of the axle with the platform is sufficient to create a lever. In a typical usage configuration, when the load is tipped the lever thus formed will cause the platform to pivot around the horizontal axis of one of the axles and lift the other axle and wheel combination off the ground and to keep the entire surface of the platform substantially against the bottom of the load. With the load is tipped slightly the entire load and set of assemblies can be easily pivoted around a vertical axis by one person, with each wheel rotating at an individual speed thereby reducing the friction and reducing the potential of scuffing the support surface.

The wheels used in the assembly consist entirely of commonly available ball or roller bearings. All of the wheels in the assemblies of the system are identical. A thin spacer is used between any two adjacent wheels to reduce friction between the wheels.

The platform consists of a horizontal base and a vertical side wall. The vertical side wall is integrated with the horizontal base and coincides with the long side of the base, the vertical side wall being intended for use in some applications as a stop against the side of the load. The top surface of the platform has a plurality of extrusions extending a small distance upward, providing a rough gripping surface.

A resilient pad, usually made of wood, rests on the rough surface of the platform and is removably attached to the platform with at least one screw. The pad is of length and width equal to or less than the length and width respectively of the platform. The thickness of the pad is somewhat greater than the distance between the top of any of the wheels and the top surface of the platform. The thickness of the pad is sufficient to provide clearance between the bottom of the load and the top of any wheel. The pad is intentionally easy and inexpensive to remove and replace because this element receives wear and tear from heavy loads.

In one type of application it is desirable to place one assembly at each of the opposite sides of the load, along the axis of the approximate center of gravity of the load, to enable the easy tilting of the load to one end or the other, thereby raising one of end of the assembly with the attached wheels, off the ground.

In a second type of application it is desirable to place the entire assembly, including all of the wheels, completely under the load. In this case the addition of a removable bolster consisting of a length of commonly available lumber, such as a 2×4, is employed on top of the pad as an additional spacer.

In a third type of application it is desirable to use an additional third assembly as a steering member, at one end of the load. In this case the bolster on the third assembly is of sufficient length to extend beyond the end of the load, the extended portion of the bolster being used as the steering arm. The end of the long bolster can be quite easily moved to one side or the other, causing the assembly to rotate horizontally around the approximate vertical center axis of the assembly and thereby changing the direction travel of the load.

Thus the system consists of a plurality of assemblies in any of several configurations together with a load, creating a movable, steerable combination of elements.

### BRIEF DESCRIPTION OF THE DRAWINGS

For a fuller understanding of the nature and objects of the invention, reference should be had to the following detailed description taken in connection with the accompanying drawings in which:

FIG. 1 is an end view of one of the assemblies;

FIG. 2 is a top view of one of the assemblies;

FIG. 3 is a bottom view of one of the assemblies;

FIG. 4 is a side view of one of the assemblies;

FIG. 5 is an end view of a first type of system usage configuration;

FIG. 6 is an end view of a second type of system usage configuration;

FIG. 7 is a top view of a third type of system usage configuration.

Similar reference characters refer to similar parts throughout the several views of the drawings.

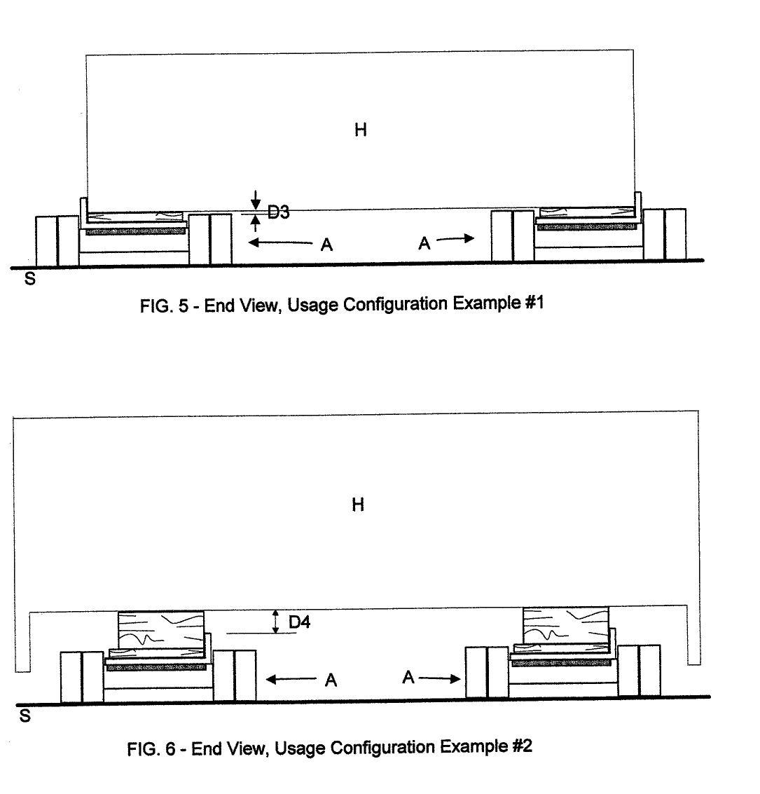

The drawing figures included herein represent the preferred embodiment of the present invention. FIGS. 14 are of various aspect views of one assembly. FIGS. 5-7 represent views of multiple assemblies as used in three different applications.

### DETAILED DESCRIPTION OF THE PREFERRED EMBODIMENT

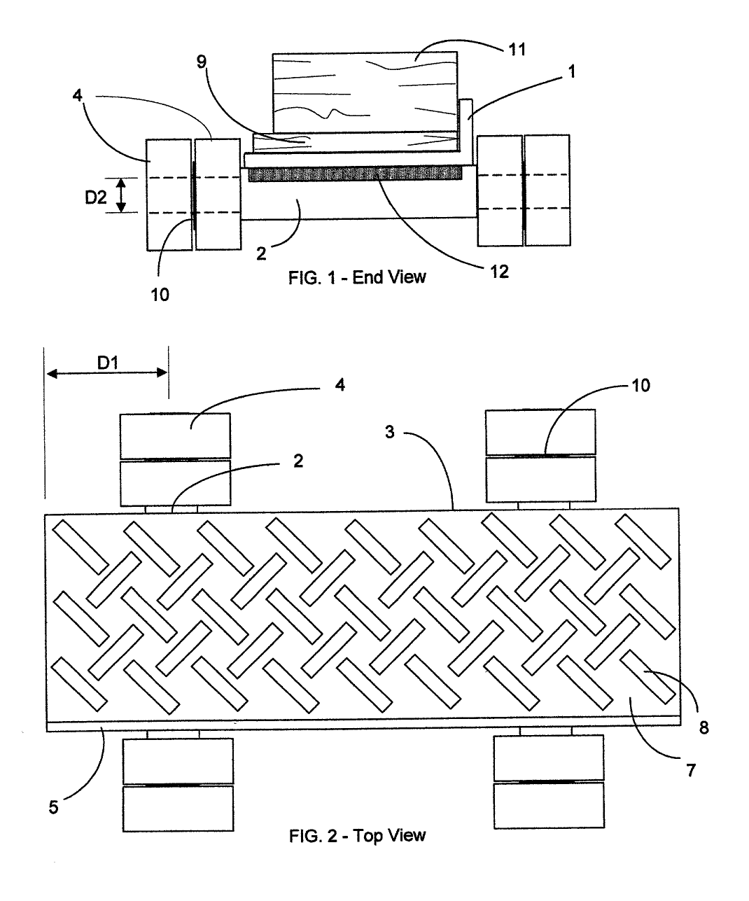

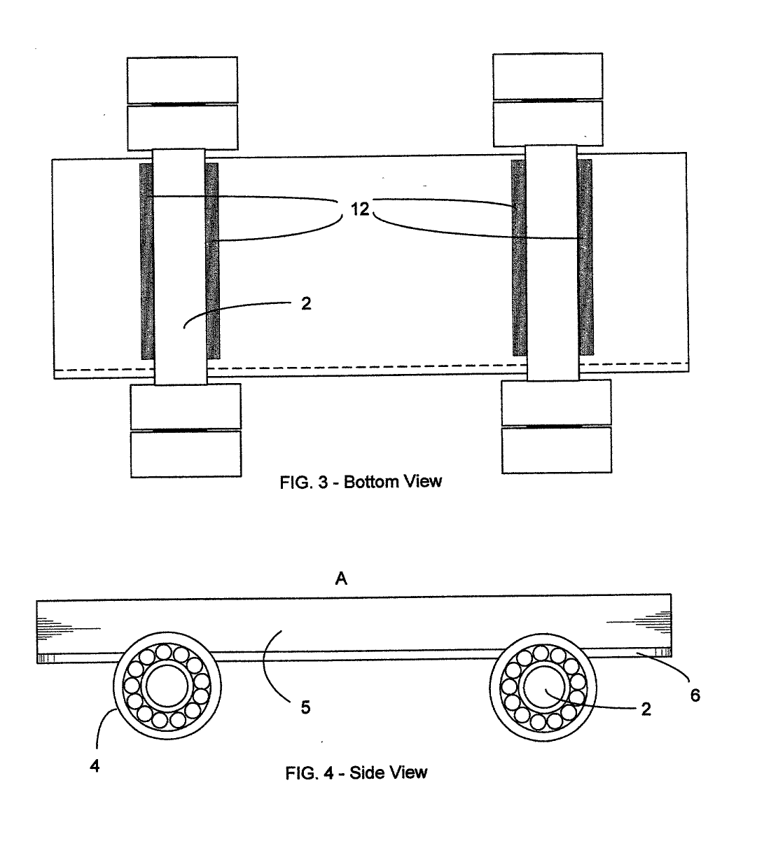

As shown in FIGS. 1 through 7, the preferred embodiment of the present invention comprises a plurality of substantially identical wheeled platform devices each generally indicated as (A), specifically configured for moving heavy loads of up to 10,000 pounds in weight over substantially flat, hard surfaces (S).

The system is for transport of a heavy load (H) two or more wheeled assemblies (A), over an essentially flat hard surface (S). The system consists of a plurality of assemblies (A), each consisting of a durable, rigid, elongated platform (1) supported by two axles of a durable, rigid material, each axle (2) extending outwardly from and perpendicular to the long side (3) of the platform, each axle (2) having multiple wheels at each end, each wheel (4) being a bearing of ball or roller type and of the same dimensions as every other wheel in the assembly.

The platform (1) consists of a horizontal base and an integrated vertical side wall (5) at right angles to the base (6) and along the long side of the base. This side wall is used in some applications as a stop against the side of a load as an aid in positioning and aligning the assembly and to prevent movement of the assembly under the load while in motion. Each end of the platform (1) extends a distance (D1) beyond the line of intersection of the axle (2) with the bottom of the platform (1). The platform has an upper surface (7) with a plurality of raised extrusions (8) at various angles to one another. On this rough surface is a removably attached pad (9), the top surface of which comes in direct contact with the load (H). The pad (9) is of sufficient thickness to provide space (D3) between the top of the wheels and the bottom of the load (H).

Each axle (2) consists of a rod of durable, rigid material, which is sufficient in diameter to raise the platform to within a minimal distance below the top of the wheel. The axle (2) is securely and rigidly attached to the bottom of the platform base. At the end of each axle is a portion of reduced diameter (D2) sufficient to securely hold the wheels on the axle.

Two identical bearings are pressed on to each reduced-diameter portion of each axle, with a thin spacer (10) placed between the two bearings (4). The bearings are the wheels.

The pad (9) acts as both a shock absorber and oil absorber, plus prevents slippage of the heavy load (H) being moved. The pad (9) is held in place with one or more screws, screwed into hole(s) formed in the platform (6).

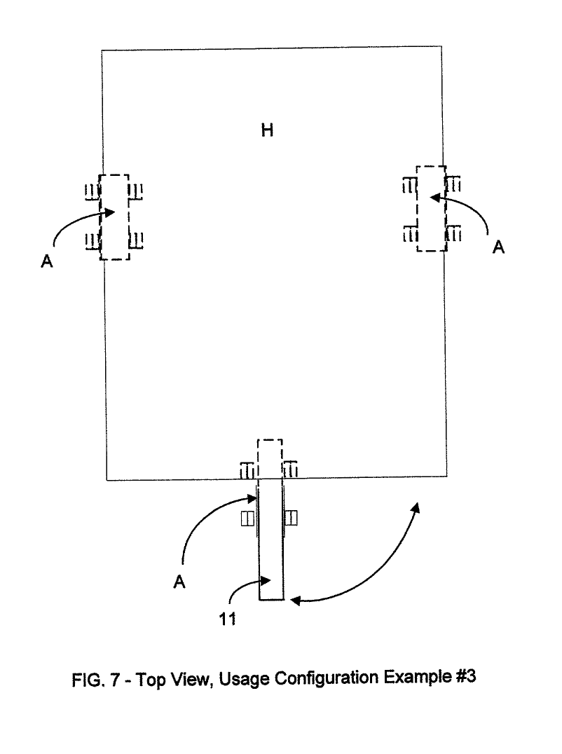

In some situations it is desirable to place the assembly (1) completely under the bottom of the load (H), as indicated in FIG. 6, in which case a removable bolster (11) made of commonly available lumber such as a 2×4 is used on top of the pad (9) to provide a flat surface of support which provides clearance above the edge of the vertical side wall (5) of the platform (4) of distance (D4). The bolster (11) may be used in some instances as a steering arm, as indicated in FIG. 7. The pad (9) and bolster (11) are designed to be easily and inexpensively replaced, as they are the components which will receive most of the wear-and-tear involved in the use of the system.

As thus constructed and used the present invention provides a system which will allow the maneuvering of a heavy, bulky load in an area of limited space.

Although the invention has been described and illustrated with respect to a preferred embodiment thereof, it is not to be so limited since changes may be made therein which are within the fully intended scope of the invention.

While certain novel features of this invention have been shown and described and are pointed out in the annexed claims, it will be understood that various omissions, substitutions and changes in the forms and details of the device illustrated and in its operation can be made by those skilled in the art without departing from the spirit of the invention.

What is claimed as invention is:

1. A system for transport of heavy loads over essentially flat hard surfaces, comprising a plurality of assemblies;
each of said assemblies having an elongated platform rigidly attached to and on top of two axles, each of said axles having a plurality of wheels rotatably attached thereon;
each of said axles being of a first diameter in the center portion to optimally reduce the clearance between the bottom of said axle and the ground, with the objective of minimizing said clearance, and of a second diameter at the ends, said second diameter being determined by specifications of wheels attached thereon;
each of said axles extending outwardly from and perpendicular to the long side of said platform, being permanently and securely attached to the bottom of said platform, at a distance inwardly from the short side of said platform such that the portion of said platform extending outwardly along an imaginary line perpendicular to the axis of said axle at each end of said assembly is sufficient to create a lever which will keep the entire surface of said platform substantially against the bottom of said load when said load is tipped in either direction perpendicular to the axis of said axles, said tipping action causing one of said axles to be elevated with respect to the axle at the opposite end of said platform;
each of said axles having a plurality of wheels at each end;
each of said wheels consisting entirely of a commonly available bearing of ball or roller type;
said platform having (a) a horizontal base and (b) a vertical side wall integrated with said horizontal base and coinciding with the long side of said base, said vertical side wall being intended for use in some applications as a stop against the side of said load;
the top of said platform having a plurality of extrusions extending a small distance from said top surface;
a pad removably attached to the top of said platform, of length and width equal to or less than the length and width respectively of said platform, the thickness of said pad being somewhat greater than the distance between the top of any of said wheels and the top surface of said platform;
a thin spacer between any two adjacent wheels;

2. An assembly of claim 1 in which said pad is made of wood.

3. An assembly of claim 1 with the addition of a removable bolster consisting of a length of commonly available lumber such as a 2×4, said bolster being provided to use on top of said pad as an additional spacer to enable placement of said assembly completely under said load, said bolster optionally being of sufficient length to extend beyond the end of said load, said extended portion of said bolster being intended for use as a steering arm.
